(19) United States
(12) Patent Application Publication
(10) Pub. No.: US 2012/0274510 A1
(43) Pub. Date: Nov. 1, 2012

(54) APPARATUS AND METHOD FOR ESTIMATING THE LOCATION OF A PORTABLE TERMINAL

(75) Inventors: Seung-Yoon LEE, Gyeonggi-do (KR); Do-Hyoung CHUNG, Seoul (KR); Myeong-Woo KOO, Gyeonggi-do (KR)

(73) Assignee: SAMSUNG ELECTRONICS CO., LTD., Gyeonggi-Do (KR)

(21) Appl. No.: 13/189,740

(22) Filed: Jul. 25, 2011

(30) Foreign Application Priority Data
Apr. 27, 2011 (KR) 10-2011-0039313

(51) Int. Cl. G01S 19/48

(52) U.S. Cl. 342/357.31

(57) ABSTRACT

An apparatus and method for location estimation in a portable terminal are provided. An operation of the portable terminal includes, if a location estimation function is activated, determining whether a reference location corresponding to a cell IDentifier (ID) of a currently connected cell is prestored, determining a search frequency range of a Global Positioning System (GPS) signal using the stored reference location, and estimating a location of the portable terminal using the GPS signal detected in the search frequency range.

### CLAIM OF PRIORITY

This application claims the benefit of the earlier filling data, under 35 U.S.C. §119, from patent application No. Ser. No. 10-2011-0039313 filed in the Korean Intellectual Property Office on Apr. 27, 2011, the contents of which are incorporated by reference in its entirety

### BACKGROUND OF THE INVENTION

1. Field of the Invention

The present invention relates to a portable terminal. More particularly, the present invention relates to an apparatus and method for estimating the location of a portable terminal using a Global Positioning System (GPS) signal.

2. Description of the Related Art

A Global Positioning System (GPS) is a satellite navigation system for calculating a user's current location by receiving a signal transmitted from a GPS satellite. The GPS is generally used in a navigation device for an airplane, a ship, an automobile, etc. The GPS is also widely used in a portable terminal such as a smart phone, a tablet Personal Computer (PC), etc.

With a growing demand in various services based on location estimation, a method of calculating a location of the portable terminal using an Internet Protocol (IP) network is being standardized in a standard organization such as an Open Mobile Alliance standardization (OMA) group. For example, a service for requesting a location value can be performed using a Secure User Plane Location (SUPL) protocol.

According to the SUPL, a reference location is used when performing location estimation. The use of the reference location can decrease a range of a frequency window used for satellite searching, thereby resulting in a significant shorter search time for a satellite signal. For example, a standalone method generally used in a Code Division Multiple Access (CDMA) scheme can also be used if a CDMA time and reference location information are provided from a base station. In this case, the portable terminal can decrease a location estimation time by decreasing the range of the frequency windoby using the reference location. However, if the reference location information is not provided from the base station, a reference location cannot be used when performing location estimation, and thus the location estimation time is relatively increased.

Accordingly, a method of reducing a location estimation time is required even when the reference location information is not provided from a network.

### SUMMARY OF THE INVENTION

Accordingly, the present invention provides an apparatus and method for reducing a time required for performing the location estimation in a portable terminal.

Another exemplary aspect of the present invention is to provide an apparatus and method for reducing time required for location estimation in a situation where reference location information is not provided from a network in a portable terminal.

Another exemplary aspect of the present invention is to provide an apparatus and method for determining a reference location required for location estimation in a portable terminal.

Another exemplary aspect of the present invention is to provide an apparatus and method for generating reference location information required for location estimation using a location estimation result in a portable terminal.

In accordance with an aspect of the present invention, a method of operating a portable terminal includes: if a location estimation function is activated, determining whether a reference location corresponding to a cell IDentifier (ID) of a currently connected cell is stored, determining a search frequency range of a Global Positioning System (GPS) signal using the stored reference location, and estimating a location of the portable terminal using the GPS signal detected in the search frequency range.

In accordance with another aspect of the present invention, a portable terminal apparatus includes a controller for determining whether a reference location corresponding to a cell ID of a currently connected cell is stored, if a location estimation function is activated, and a GPS module for determining a search frequency range of a GPS signal using the stored reference location, and for estimating a location of the portable terminal using the GPS signal detected in the search frequency range.

Other exemplary aspects, advantages and salient features of the invention will become more apparent to those skilled in the art from the following detailed description, which, taken in conjunction with the annexed drawings, discloses exemplary embodiments of the invention in more detail

### BRIEF DESCRIPTION OF THE DRAWINGS

The above features and advantages of certain exemplary embodiments of the present invention will become more apparent from the following detailed description when taken in conjunction with the accompanying drawings, in which:

FIG. 1 illustrates a process of generating a cell IDentifier (ID) cache in a portable terminal according to an exemplary embodiment of the present invention;

FIG. 2 is a flowchart illustrating a process of operating a portable terminal according to an exemplary embodiment of the present invention; and

FIG. 3 is a block diagram of a portable terminal according to an exemplary embodiment of the present invention.

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of exemplary embodiments of the present invention as defined by the claims. The description includes various specific details to assist in that understanding but these details are to be regarded as merely exemplary. Accordingly, those of ordinary skill in the art will recognize that various changes and modifications of the exemplary embodiments described herein can be made without departing from the scope and spirit of the invention as defined by the appended claims. Further, descriptions of well-known functions and constructions may be omitted for conciseness and so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Hereinafter, preferred embodiments of the present invention will be described below with reference to the accompanying drawings.

The present invention described hereinafter relates to a technique for reducing a time required for location estimation by using a Global Positioning System (GPS) in a portable terminal. In the following description, the portable terminal may include a cellular phone, a Personal Communication System (PCS), a Personal Digital Assistant (PDA), an International Mobile Telecommunication-2000 (IMT-2000) terminal, a smart phone, etc.

A GPS satellite rotates a determined orbit at a speed of about 800 m/s. Thus, a Doppler frequency of up to 8.4 kHz can be generated. Accordingly, an apparatus which attempts to detect a GPS satellite signal has to perform searching on a frequency band in the range of up to 10 kHz. A specific value of the Doppler frequency is determined according to a speed of increasing or decreasing a distance between an observer and a caller who generates the signal. In this case, even if the same caller is observed, an observation speed varies depending on a relative movement direction of the caller with respect to the observer. Therefore, the Doppler frequency experienced by the portable terminal with respect to the GPS satellite that rotates the determined orbit varies depending on a location of the portable terminal. Therefore, if an approximate location of a region where the device is located can be known, the device can decrease a frequency range for searching for the GPS signal, thereby being able to reduce a search time for the GPS satellite signal.

In the present invention, the reference location implies an approximate location of a region where the device is located. For example, the reference location may be a latitude and longitude of a base station to which the portable terminal is connected. That is, the portable terminal can utilize base station's location information provided from the network as the reference location information. However, if the reference location information is not provided from the network, the portable terminal according to the exemplary embodiment of the present invention determines the reference location on its own on the basis of the following method.

Briefly, when location estimation is performed, the portable terminal stores a reference location corresponding to a cell IDentifier (ID) by using a location estimation result so that the reference location is used at a later time. In doing so, reference location information corresponding to the cell ID is secured. Accordingly, even if the reference location information is not provided from the network, when location estimation is performed at a later time within a cell having the cell ID, the portable terminal can reduce a required time to process the estimation using the stored reference location information. For convenience of explanation, data for storing the reference location information corresponding to the cell ID is hereinafter referred to as a ‘cell ID cache’.

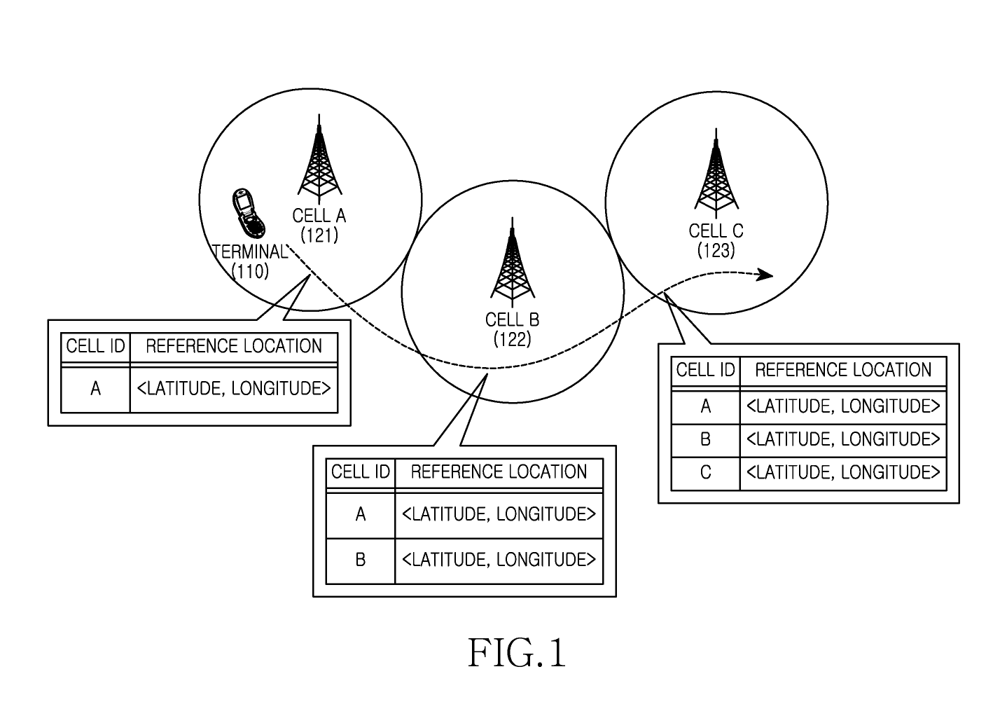

FIG. 1 illustrates a process of generating a cell ID cache in a portable terminal according to an exemplary embodiment of the present invention.

Referring to FIG. 1, a portable terminal 110 performs location estimation while moving across a cell-A 121, a cell-B 122, and a cell-C 123. While connected to the cell-A 121, the portable terminal 110 determines a reference location corresponding to the cell-A 121, and writes the determined reference location and the cell ID of the cell-A 121 in the cell ID cache. Although the reference location is expressed by <latitude, longitude> in FIG. 1, it can also be expressed by another format. In this case, the reference location can be determined in various manners according to a detailed exemplary embodiment of the present invention. For example, the portable terminal 110 can determine the reference location to an average of all location values measured while connected to the cell-A 121. Alternatively, the portable terminal 110 can determine the reference location to a first measured location and a last measurement location in the cell-A 121, or a location at a predefined time point while connected to the cell-A 121.

As a user of the portable terminal 110 roams to the cell-B 122 and the cell-C 123, the cell ID of the connected cell is changed. Each time the cell connection is changed, the portable terminal 110 determines a reference location corresponding to the cell, and writes the cell ID of the cell and the determined reference location to the cell ID cache as shown in FIG. 1.

As described above, the portable terminal according to the exemplary embodiment of the present invention can generate the cell ID cache, and can be used later to determine the reference location using the cell ID cache when performing location estimation. If the cell ID cache is not generated in advance, or if the cell ID cache is generated but reference information corresponding to a cell ID of a currently connected cell is not stored, the portable terminal determines a specific country to which a currently connected network belongs, and uses a predefined location in the determined country as the reference location. In this case, the predefined location of the country can be determined according to a rule pre-defined for each country.

Hereinafter, an operation and structure of a portable terminal for performing location estimation as described above will be explained in detail with reference to the accompanying drawings.

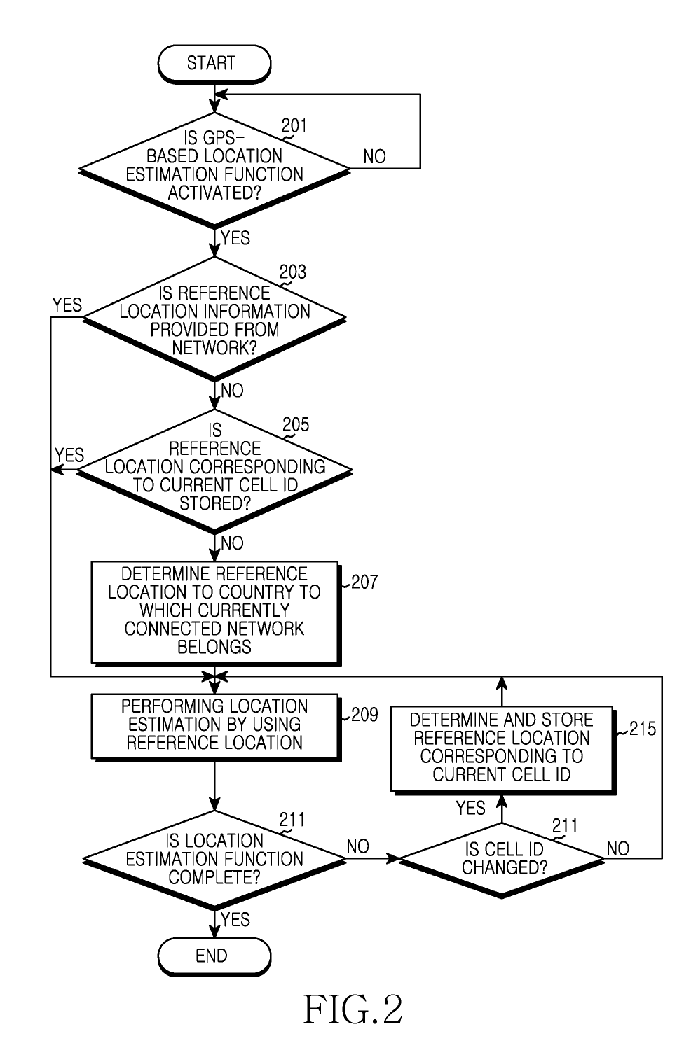

FIG. 2 is a flowchart illustrating a process of operating a portable terminal according to an exemplary embodiment of the present invention.

Referring to FIG. 2, the portable terminal determines whether a GPS-based location estimation function is activated in step 201. The location estimation function can be activated by a user's location estimation command or by execution of another application which uses a location estimation result.

If the GPS-based location estimation function is activated, proceeding to step 203, the portable terminal determines whether reference location information is provided from a network. For example, the reference location information provided from the network may include location information of a base station. If the reference location information is provided from the network, the procedure of FIG. 2 proceeds to step 209.

If the reference location information is not provided from the network, proceeding to step 205, the portable terminal determines whether a reference location corresponding to a current cell ID is stored. In other words, the portable terminal determines whether a cell ID cache is generated in advance and whether a reference location corresponding to a cell ID of a currently connected cell is stored to the cell ID cache. If the reference location corresponding to the current cell ID is stored, the procedure of FIG. 2 proceeds to step 209.

Otherwise, if the reference location corresponding to the current cell ID is not stored, proceeding to step 207, the portable terminal determines the reference location to a predefined location in a country to which the currently connected network belongs. That is, since the reference location is not provided from the network and there is no reference location stored in advance to the cell ID cache, the portable terminal determines the reference location by using the country to which the currently connected network belongs. The predefined location of the country can be determined according to a rule pre-defined for each country.

In step 209, the portable terminal performs location estimation by using the reference location. Specifically, the portable terminal determines a frequency band for searching for a GPS signal by using the reference location, searches for the GPS signal within the determined band, and then performs location estimation by using the GPS signal. The location estimation of step 209 is persistently performed until the location estimation function is complete in step 211.

In step 211, the portable terminal determines whether the location estimation function is complete. That is, the portable terminal determines whether the location estimation function is complete by a location estimation stop command of a user or by the completion of another application which uses a location estimation result. If the location estimation function is complete, the procedure of FIG. 2 ends.

Otherwise, if the location estimation function is not complete, proceeding to step 213, the portable terminal determines whether the cell ID is changed. The cell ID is changed when a cell to which the portable terminal is connected is changed due to movement of the user. In other words, the cell ID is changed due to handover, and the change of the cell ID implies a change of a serving cell.

If the cell ID is changed, proceeding to step 215, the portable terminal determines a reference location corresponding to a current cell ID, and stores the reference location to the cell ID cache. For example, the reference location can be expressed in the format of <latitude, longitude> or another format. In this case, the reference location can be determined in various manners according to a detailed exemplary embodiment of the present invention. Similarly, the portable terminal can determine the reference location to an average of all location values measured while connected to a corresponding cell. In another example, the portable terminal can determine the reference location to a first measured location and a last measurement location in the corresponding cell, or a location at a predefined time point while connected to the corresponding cell. Subsequently, the procedure returns to step 209.

In the first exemplary embodiment of the present invention described with reference to FIG. 2 above, if the reference location is not provided from the network and if there is no reference location written in advance to the cell ID cache, then the portable terminal determines the reference location by using the country to which the currently connected network belongs in step 207. However, according to another exemplary embodiment of the present invention, step 207 can be omitted. In this case, if the reference location is not provided from the network and if there is no reference location written in advance to the cell ID cache, the portable terminal searches for the GPS signal without the use of the reference location.

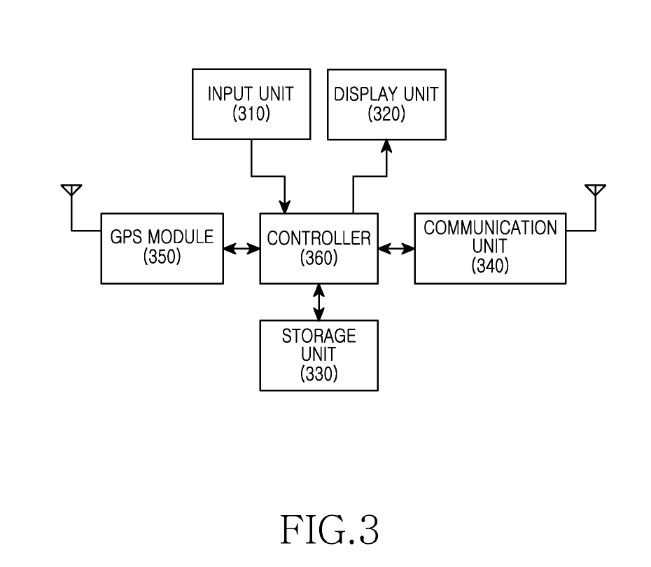

FIG. 3 is a block diagram of a portable terminal according to an exemplary embodiment of the present invention.

Referring to FIG. 3, the portable terminal includes an input unit 310, a display unit 320, a storage unit 330, a communication unit 340, a GPS module 350, and a controller 360.

In operation, the input unit 310 recognizes an input generated by a user, and provides information corresponding to the input to the controller 360. That is, the input unit 310 processes the user's input by means of a key pad, a touch screen, a touch pad, a special function button, etc.

The display unit 320 displays status information, which is generated while the terminal operates, and alphanumeric characters, images, etc., produced when an application program is executed. That is, the display unit 320 displays image data provided from the control unit 360 on a visual screen. For example, the display unit 320 may be a Liquid Crystal Display (LCD), an Organic Light-Emitting Diode (OLED), etc.

The storage unit 330 stores a basic program for operating the portable terminal, an application program, and data such as user contents. In particular, the storage unit 330 stores a cell ID cache generated by using a location estimation result. For example, the cell ID cache includes a cell ID and a reference location corresponding to the cell ID. For example, the reference location can be expressed in the format of <latitude, longitude> or another format.

The communication unit 340 provides an interface for signal transmission and reception with respect to the base station of a mobile network through a radio channel. That is, the communication unit 340 transmits Transmit (Tx) data by converting the data into a Radio Frequency (RF) signal, and converts the RF signal received through the antenna into Receive (Rx) data. In this case, the communication unit 340 performs conversion between the data and the RF signal according to a communication system protocol.

The GPS module 350 performs GPS-based location estimation under the control of the controller 360. Specifically, the GPS module 350 receives a GPS satellite signal, and estimates a current location by using data included in the GPS satellite signal. For this, the GPS module 350 searches for and detects the GPS signal. In this case, the GPS module 350 searches for the GPS signal by using a reference time, reference location, etc., provided from the controller 360. Specifically, the GPS module 350 determines a frequency band for searching for the GPS signal by using the reference location, searches for the GPS signal within the determined band, and then performs location estimation by using the GPS signal.

The controller 360 controls overall functions for respective constitutional elements of the portable terminal. In particular, according to the exemplary embodiment of the present invention, the controller 360 controls functions for location estimation. Specifically, the controller 360 generates a cell ID cache by using location information estimated by the GPS module 350, and provides reference location information to the GPS module 350 by using the cell ID cache. A detailed operation of the controller 360 for the location estimation is as follows.

The controller 360 activates the GPS module 350 according to the execution of an application which uses a user's command or location estimation. In this case, the controller 360 determines whether the reference location information is provided from the network through the communication unit 340. If the reference location information is not provided from the network, the controller 360 determines whether a reference location corresponding to a current cell ID is stored in the storage unit 330. In other words, the controller 360 determines whether the cell ID cache is stored in the storage unit 330 and whether a reference location corresponding to a cell ID of a currently connected cell is stored to the cell ID cache. If so, the storage unit 330 provides the reference location to the GPS module 350; otherwise, the controller 360 provides a predefined location in a country, to which the currently connected network belongs, to the GPS module 350 as the reference location. However, in alternate exemplary embodiment, if the reference location corresponding to the current cell ID is not stored, the controller 360 may not provide the reference location.

While location estimation is performed by the GPS module 350, the controller 360 receives a location estimation result. In this case, the controller 360 adds the cell ID and a reference location corresponding to the cell ID to the cell ID cache whenever the cell ID is changed. Specifically, when the cell ID is changed, the controller 360 determines the reference location corresponding to the current cell ID, and stores the reference location to the cell ID cache. In this case, the reference location can be determined in various manners according to a detailed exemplary embodiment of the present invention. As stated previously, the controller 360 can determine the reference location to an average of all location values measured while connected to the cell. In another example, the controller 360 can determine the reference location to a first measured location and a last measurement location in the cell, or a location at a predefined time point while connected to the cell.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While a detailed embodiment has been described in the present invention, it would be obvious to those of ordinary skill in the art that various changes may be made without departing from the scope of the present invention.

What is claimed is:

1. A method of operating a portable terminal, the method comprising:
determining whether a reference location corresponding to a cell IDentifier (ID) of a currently connected cell is prestored when a location estimation function is activated;
determining a search frequency range of a Global Positioning System (GPS) signal using the stored reference location; and
estimating a location of the portable terminal using the GPS signal detected in the search frequency range.

2. The method of claim 1, further comprising:
determining whether the cell ID is changed after the estimating of the location of the portable terminal;
determining a new reference location corresponding to the changed cell ID using a location estimation result; and
storing the changed cell ID and corresponding the new reference location.

3. The method of claim 2, wherein the determining of the reference location corresponding to the cell ID using the location estimation result comprises determining the reference location based on an average of all location values measured while connected to a new cell.

4. The method of claim 2, wherein the determining of the reference location corresponding to the cell ID using the location estimation result comprises determining the reference location based on a location at a predefined time point while connected to a new cell.

5. The method of claim 1, further comprising:
determining the reference location based on a predefined location in a country to which the currently connected network belongs when the reference location corresponding to the cell ID of the currently connected cell is not prestored.

6. The method of claim 1, further comprising:
if the reference location is provided from a network, performing location estimation using the reference location provided from the network.

7. The method of claim 6, wherein the reference location provided from the network includes a location of a base station.

8. The method of claim 1, wherein the cell ID and the corresponding reference location is prestored in a cell ID cache whenever the cell ID is changed.

9. A portable terminal apparatus, the apparatus comprising:
a controller for determining whether a reference location corresponding to a cell IDentifier (ID) of a currently connected cell is prestored when a location estimation function is activated; and
a Global Positioning System (GPS) module for determining a search frequency range of a GPS signal using the stored reference location and for estimating a location of the portable terminal using the GPS signal detected in the search frequency range.

10. The apparatus of claim 9, wherein if the cell ID is changed after estimating of the location of the portable terminal, the controller stores a new reference location corresponding to the changed cell ID using a location estimation result.

11. The apparatus of claim 10, wherein the controller determines the reference location based on an average of all location values measured while connected a new cell.

12. The apparatus of claim 10, wherein the controller determines the reference location based on a location at a predefined time point while connected to a new cell.

13. The apparatus of claim 9, wherein the controller determines the reference location based on a predefined location in a country to which the currently connected network belongs when the reference location corresponding to the cell ID of the currently connected cell is not prestored.

14. The apparatus of claim 9, wherein if the reference location is provided from a network, the GPS modules performs location estimation by using the reference location provided from the network.

15. The apparatus of claim 14, wherein the reference location provided from the network includes a location of a base station.

16. The apparatus of claim 9, wherein the controller stores the cell ID and the reference location corresponding to the cell ID in a cell ID cache whenever the cell ID is changed.
